(19) United States
(12) Patent Application Publication
(10) Pub. No.: US 2012/0107778 A1
(43) Pub. Date: May 3, 2012

(54) INTERACTIVE DISPLAY BOARD AND METHOD FOR TEACHING SPEECH AND COMMUNICATION SKILLS USING SAID INTERACTIVE DISPLAY BOARD

(76) Inventor: Patricia M. SCHUETTE, League City, TX (US)

(21) Appl. No.: 13/285,802

(22) Filed: Oct. 31, 2011

Related U.S. Application Data
(60) Provisional application No. 61/408,758, filed on Nov. 1, 2010.

(51) Int. Cl. G09B 19/04

(52) U.S. Cl. 434/185

(57) ABSTRACT

The present invention is an interactive display board and method for teaching speech and communication skills through the interactive display board to an individual with language disabilities. A target response formed of sound units is requested from the individual. A plurality of visual indicators, such as lights, corresponds to each sound unit of the target response. The visual indicators are presented, and each sound unit is associated with a corresponding visual indicator. The association is a different sensory interaction, such a pressing a button, activating a switch, or pointing. The display board includes visual indicators with pressure-activated switches for the association of the sound units and visual indicators. The target response is the produced verbally by the individual concurrent with repeating the interaction with the visual indicators by the individual.

### RELATED U.S. APPLICATIONS

The present application claims priority under U.S. Code Section 119(e) from a provisional patent application, U.S. Patent Application No. 61/408,758, filed on 1 Nov. 2010 and entitled “INTERACTIVE DISPLAY BOARD AND METHOD FOR TEACHING SPEECH AND COMMUNICATION SKILLS USING SAID INTERACTIVE DISPLAY BOARD”.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present invention relates to an interactive display board and method of using the display board for teaching speech and communication skills. More particularly, the present invention relates to an interactive display board to teach speech and communication skills to individuals with language disabilities.

2. Description of Related Art Including Information Disclosed Under 37 CFR 1.97 and 37 CFR 1.98

Communication between human beings is an exchange of thoughts, ideas, and feelings, which enable participation in society. Individuals may evidence language disabilities such as an autism spectrum disorder, syntactic deficits, apraxia, and/or articulation deficits which impair their ability to communicate verbally. These individuals are taught language and communication skills in order to improve quality of life and integration into their communities.

Individuals with autism spectrum disorders or other communication challenges are often strong visual learners. A multi-sensory approach utilizes the visual abilities of these individuals to learn language skills, taking advantage of the stronger visual skills to increase mastery of verbal and auditory skills. This approach taps into an individual's visual strengths, increasing the ability to focus, visualize, and organize thoughts to achieve an expected verbal communicative outcome.

In the past, various patents have been issued relating to devices and methods for teaching language skills. For example, U.S. Pat. No. 6,623,273, issued to Evangelisti on Sep. 23, 2003, teaches a portable speech therapy device. The device has a series of color indicator lights mounted on a housing. A patient is taught to make a specific sound in response to a specific one of the plurality of lights being activated. A controller turns the lights on and off in a programmed sequence. The lights are associated with verbal responses by the patient.

U.S. Pat. No. 4,915,632, issued to Leff et al. on Apr. 10, 1990, discloses a communication and education aid. The device has a housing, a series of display cards, and a plurality of lights associated with the display cards. The device is operated by a pressure pad remote from the housing. Additionally, there is a stage area on top of the housing for placement of items corresponding with the display cards. The device can be used by non-verbal patients to select desired items such as food, and also for speech training. Lights and touch-activation of the lights present multi-sensory cues for communicating.

U.S. Pat. No. 4,001,948, issued to Wolfe on Jan. 11, 1977, discloses a light response teaching system. The system has a housing with a display panel. The display panel has a number of illuminated panels on which partially transparent cards having imprinted images are placed. The illuminated panels have touch-sensitive switches. The system has a number of teaching settings. The concept of pressure switch-controlled lights appears to well known as a teaching tool.

U.S. Pat. No. 5,015,179, issued to Resnick on May 14, 1991, teaches a speech monitor, providing a digital image of detected speech. The visual data is presented to the speaker to provide information related to the pitch and volume of speech. The speaker utilizes the visual data to adjust the speech pattern, enabling correction of pitch and volume.

U.S. Patent Application Publication No. 2002/0090596, by Sosoka et al. and published on Jul. 11, 2002, describes a system and method for teaching phonics. A series of letters is presented in a set of blocks, forming various phonemes generated by a computer. A control console allows the user to manipulate the letters on blocks. The system audibly plays the phoneme exposed on the blocks to the user.

U.S. Patent Application Publication No. 2007/0259318, by Harrison and published on Nov. 8, 2007, describes a system for interacting with developmentally challenged individuals. The invention includes a user input device, a visual display, an audio output device, and a processing system. The processing system is connected to control the visual display, the input device, and the audio output device and operates to display one or more photographic images on the visual display based on a mastery level of the developmentally challenged individual. The developmentally challenged individual communicates by selecting one of the predetermined photographic images from the visual display using the user input device. In response to this selection, the processing system controls the audio output device to play audio vocalizations corresponding to the selected photographic image.

It is an object of the present invention to provide an interactive display board to promote oral expressive language skills in individuals with language disabilities. These individuals may have limited or no communication skills, such as individuals with phonemic deletions.

It is an object of the present invention to provide an interactive display board to minimize use of auditory cues when teaching language skills. The present invention reduces auditory confusion and overstimulation, especially for individuals on the autism spectrum, who may need enhanced visual cues in systems to facilitate learning.

It is another object of the present invention to provide an interactive display board to present a multi-sensory approach to teach language.

It is still another object of the present invention to provide an interactive display board that is simple, light-weight, and user-friendly.

It is an object of the present invention to provide a method of using an interactive display board to teach verbal communication skills to individuals with language disabilities.

It is a further object of the present invention to provide a method of using an interactive display board to teach advanced communication skills to individuals with language disabilities, such as requesting, choice selection, verbal identification of visual cues, and complete sentences. In an advanced stage, an individual can apply the learned skills to creative and generative situations with different cues and indicators, either auditory or visual. In further advanced stages, an individual can apply learned skills with abstract images and pictures of objects.

These and other objects and advantages of the present invention will become apparent from a reading of the attached specification.

### SUMMARY OF THE INVENTION

The present invention is an interactive display board and method for teaching speech and communication skills through the interactive display board to an individual with language disabilities. An embodiment of the display board of the present invention includes a panel body having a flat surface and an interior volume. A plurality of lights are linearly arranged on the flat surface of the panel body and housed in the interior volume of the panel body. Each light activates by a switch corresponding to each light, and each switch operates independently. A plurality of slide members corresponds to each of the lights. Each slide member has an extended position and a retracted position. The slide member covers a corresponding light in the extended position and exposes the corresponding light in the retracted position. Each slide member is independently moved between the retracted position and the extended position. A mounting means can also be part of the panel body.

An embodiment of the method for teaching speech and communication skills using the interactive display board of the present invention includes requesting a target response to the individual with language disabilities. The target response is a verbal reply of at least one sound unit. A sound unit is a phoneme, syllable, word, phrase, or sentence, depending upon the skill level of the individual. The target response involves showing a visual target related to the target response. For example, an apple is presented, and the individual is requested to say “apple”. The relationship between the visual target and the target response can vary by skill level of the individual. Questions can be more complex than simply identifying the object of the visual target.

A plurality of visual indicators, such as lights, corresponds to each sound unit of the target response. The visual indicators are presented, and each sound unit is associated with a corresponding visual indicator. The association is a different sensory interaction, such as pressing a button, activating a switch, viewing a light, or pointing. Next, the target response is produced verbally by the individual concurrent with repeating the interaction with the visual indicators by the individual.

Another embodiment of the invention includes using the display board to present a request for the target response, present the visual indicators, associate visual indicators with each sound unit, and receiving the target response. The visual indicators are the lights on the panel body of the interactive display board. The slide members are retracted according to the number of sound units in the target response, and the instructor activates a light concurrent with reciting a sound unit verbally. The activation of the light can include turning the light on or flashing the light. These lights remain displayed to the individual, and the target response is received back from the individual verbally. When received back, the flashing can be repeated. Alternatively, the lights can be turned off before the target response is started, so as to allow the turning on of the lights to be repeated as well. The method also allows for proximity prompts, as needed for each particular individual and for each level of performance. For example, gestures and verbal prompts by an instructor may also be coordinated into the method.

The present invention provides an interactive display board and method for associating different sensory interactions, including visual and tactile cues, concurrent with auditory cues from the instructor, for learning speech and communication skills. The present invention elicits verbal responses from the individual with the language disability to increase the ability to express thoughts and communicate with others. The individual can learn language without sole reliance upon auditory cues with the present invention.

### BRIEF DESCRIPTION OF THE DRAWINGS

FIG. 1 is a perspective of an embodiment of an interactive display board of the present invention.

FIG. 2 is another perspective view of the interactive display board of FIG. 1, showing a display stage attachment.

FIG. 3 is another perspective view of the interactive display board and display stage attachment of FIG. 2, showing a side perspective view.

FIG. 4 is an exploded perspective view, showing the interactive display board and display stage attachment in a separated configuration.

FIG. 5 is an illustration of a circuit diagram, showing an embodiment of the circuitry of the lights in the interactive display board.

### DETAILED DESCRIPTION OF THE DRAWINGS

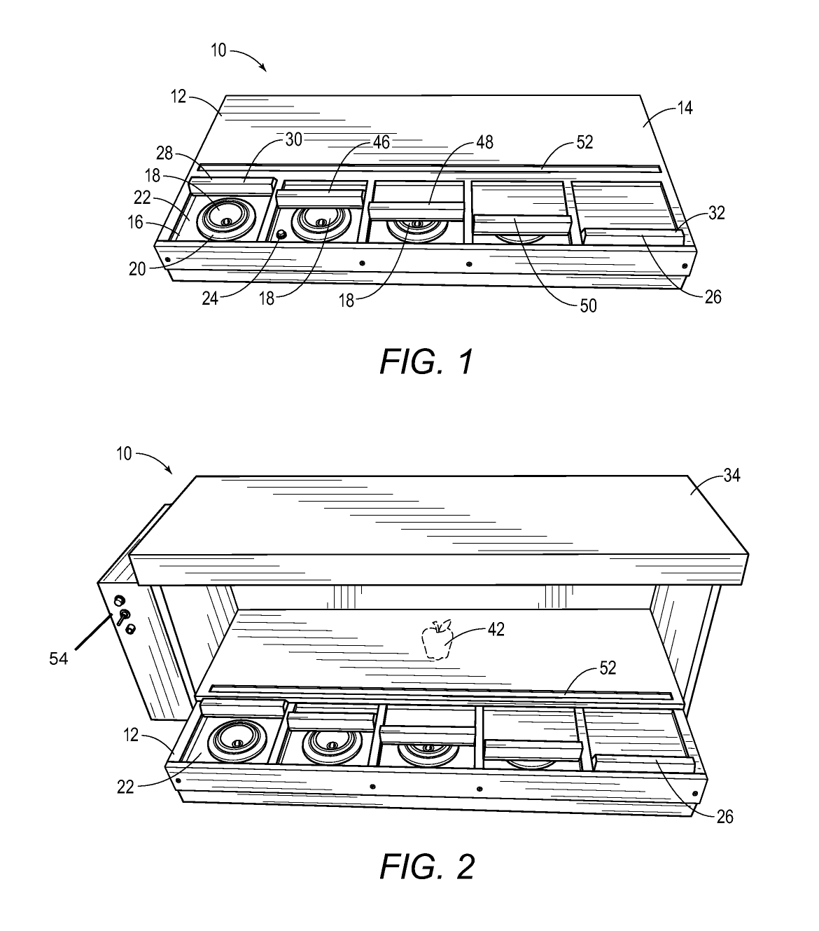

Referring to FIGS. 1-4, there is the interactive display board 10 for teaching speech and communication skills. The interactive display board 10 includes a panel body 12 having a flat surface 14 and an interior volume 16. The panel body 12 has a simple rectangular box shape and is light-weight and user-friendly. The panel body 12 can be transported easily between classrooms or stored in closets. The light-weight display board 10 can easily travel with an instructor by motor vehicle. There are optional electric plugs or other electronic requirements outside of the display board 10 itself. Additional lighting may be needed for illumination, and the display board 10 is compatible with other light sources.

There is a plurality of lights 18 are linearly arranged on the flat surface 14 of the panel body 12 and housed in the interior volume 16 of the panel body 12. Each light 18 activates by a switch 20 corresponding to each light, and each switch 20 operates independently. The switches 20 can be pressure sensors underneath each light 18, as shown at indicator 22. The switches on the lights can also be soft-touch lights or other appropriate means for use by individuals with muscular/motor disabilities. The switches can also be traditional switches, like a button 24. Any type of light 18 can be used, including but not limited to light bulbs and LED's.

A plurality of slide members 28 correspond to each of the lights 18. A slide member 28 has an extended position 32 and a retracted position 30. The slide member 28 covers a corresponding light 18 in the extended position 32 and exposes the corresponding light 18 in the retracted position 30. Each slide member 28 is independently moved between the retracted position 30 and the extended position 32. FIG. 1 shows various positions of the slide member 28 from the retracted position 30 to the extended position 32, including an opening position 46, middle position 48, closing position 50, and closed position 26. The slide members 28 control which lights 18 are displayed by the instructor to the individual.

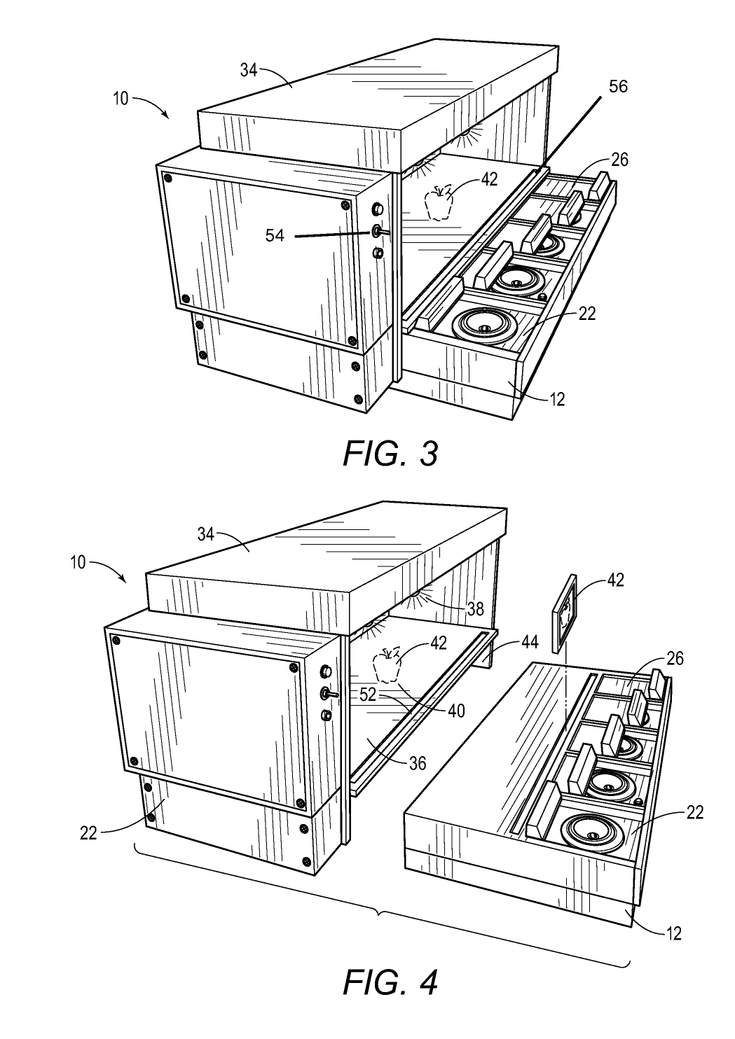

FIGS. 1 and 2 show the mounting means 52 on said panel body for requesting the target response associated with a visual display as an accessory to the interactive display board 10. The mounting means 52 can be placed on a top surface of the panel body 12 in order to hold the object 42. For the mounting means 52, the object 42 can be the actual item or an image of the item, according to the user's cognitive abilities. In particular, the mounting means 52 can be a rail or ridge or groove to hold pictures or line drawings, showing images of the item. The mounting means 52 can also hold a digital screen of a handheld device. The mounting means 52 extends parallel to the plurality of lights 18 for association of the object 42 or image of the object 42 with the visual cues. The mounting means 52 may also be compatible with the display stage 34. An image or picture of an object 42 can be mounted on the display stage 34. Alternatively, a digital screen can be placed in the display stage 34 to show the image of the object 42. The mounting means 52 in FIGS. 1 and 2 is a ridge or groove to hold pictures or a digital screen. FIGS. 2-3 show the master switch 54 to activate the plurality of lights and corresponding switches. The master switch 54 is shown on a side of the display stage 34, but alternative locations are also possible. The master switch 54 may also be positioned on the panel body 12.

FIGS. 2-4 show a display stage 34 attachment. The display stage 34 is removably engaged to the panel body 12. A locking area 44 can be used to hold the display stage 34 in position. The display stage 34 is aligned along a length of the panel body 12, such that the plurality of lights 18 extends across the stage area 36. The display stage 34 further includes a means for presenting a target response on said display stage. FIGS. 2-4 show the means for presenting as the illuminated interior of the display stage, as indicated by any known light means 38, being powered by batteries or an electric plug. The center of the stage area 36 has a focal point 40 for placement of an object 42. An alternative means for presenting is the groove 56, which can be used similar to the mounting means 52 for a display screen. An electronic photo frame or handheld electronic device can show an image of the visual target, (an object, not the actual object), and this object is associated with said target response, not the image or screen. Additionally, showing pictures and scenes can be used for advanced visual targets, depending upon the skill of the individual.

The object 42 or image of the object 42 is associated with the auditory cues provided by the instructor. The display stage isolates the use of auditory cues and multi-sensory cues. The visual cues are restricted to the lighted stage area 36 so that the individual focuses on the object 42 when formulating a verbal response. The interactive display board 10 with the display stage 34 adjusts to the skill level of the individual so that the interactive display board 10 can be used throughout the development of language skills from a basic level to an advanced level.

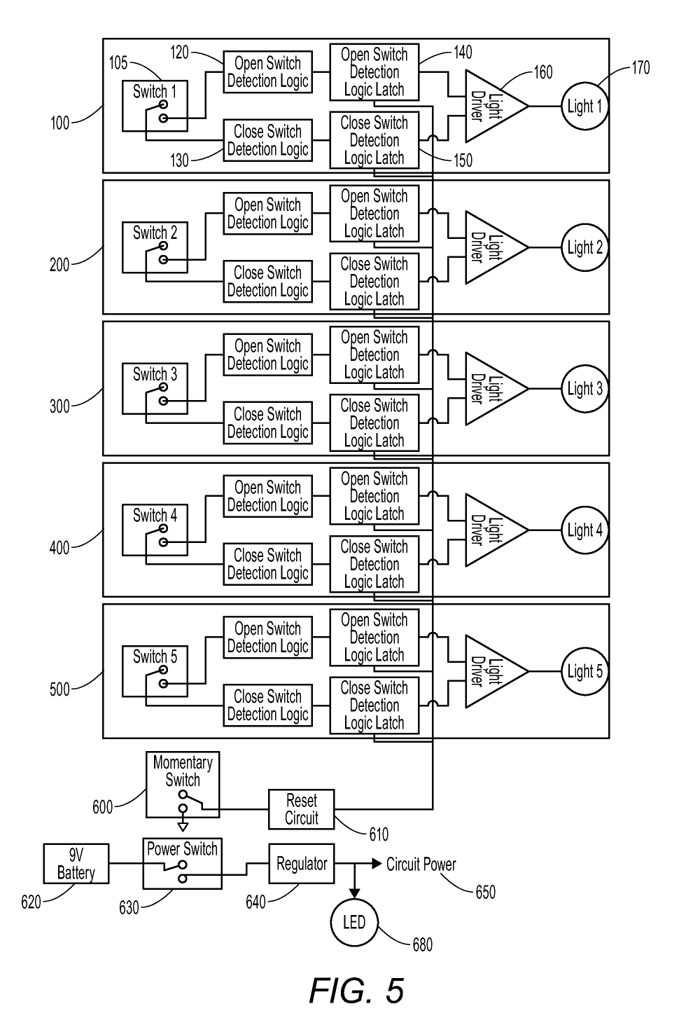

FIG. 5 shows a block diagram illustration of the major components of the circuit for the interactive display board 10 of FIGS. 1-4. The circuit comprises light-enabling switch circuits 100,200,300,400 and 500. In addition, there is a momentary switch 600 and reset circuit 610, which form a reset circuit that turns off any light that is on in response to a momentary switch 600 closure. FIG. 5 also shows the battery 620, power switch 630, regulator 640, circuit power output 650, and circuit power indicator 660 of a power section. Circuits 100,200,300,400, are 500 are identical, such that explanation of circuit 100 discloses the features of the other circuits as well.

In one embodiment, the circuit 100 includes a mechanical latching push button switch 105, the open switch detection logic 120, the close switch detection logic 130, the open switch detection logic latch 140, the close switch detection logic latch 150, the light driver 160, and the light 170 that turns on in response to depressing the switch 105. The open switch detection logic 120 and close switch detection logic 130 allow operating a light when either the mechanical switch 105 is open and closed by detection of either switch 105 state. This reset allows an instructor to conduct a learning session without having to figure out the previous state of the mechanical switch 105 before starting.

The output of 120 and 130 is fed simultaneously to open switch detection logic latch 140 and close switch detection logic latch 160, respectively. If either of the output signals from 120 and 130 is asserted, their associated switch detection logic latch outputs are set for activation. If any one of the output latches 140 or 150 is “on”, the light driver 160 is turned on causing current to flow in the light 170 to flow and thus turning the light 170 on. The light driver 160 can be a transistor or any device that would turn on the light 140. The light 170 can be any lighting device such as a light emitting diode.

A momentary switch 600 resets all the latches 180 by sending a switch closure signal to the reset circuit 610. The output of 610 is a reset signal that is broadcast to all the latches. In the case of circuit 100, latches 140 and 150 are reset, thus, turning light 170 off. Hence, any light in either 100, 200, 300, 400, or 500 is on, the reset circuit 610 will cause the light to turn off and ready for the next learning session.

In this embodiment, the circuit is provided by the 9 volt battery 620. When the power switch 630 is enabled, the 9 volt battery 630 power is supplied to the regulator 230. The regulator 640 outputs regulated circuit power 650 that is supplied to all the Interactive Display circuit components. Power indicator 660 provides an indication that power is available to the Interactive Display circuits.

The method for teaching speech and communication skills includes requesting a target response from the individual with language disabilities. The target response is at least one sound unit, usually recited by an instructor. A sound unit is a phoneme, syllable, word, phrase, or sentence, depending upon the skill level of the individual. A number of visual indicators, corresponding to each sound unit of said target response, are presented to the individual, and each sound unit of the target response is associated with a corresponding visual indicator. These visual indicators are linearly arranged on a display board. Finally, the target response is received from the individual, concurrent with the association of the visual indicators.

FIGS. 1-4 show one embodiment of the method of the present invention. The display board 10 contains at least one visual indicator 22. The plurality of visual indicators 22 corresponding to each sound unit of the target response is presented. The instructor associates each sound unit with a corresponding visual indicator 22. The visual indicators are the lights 18 on the panel body 12 of the interactive display board. The slide members 28 are placed in a retracted position 30 according to the number of sound units in the target response, and the instructor activates a light 18 concurrent with reciting a sound unit verbally. Activation of a light 18 can include turning on the light or even just flashing the light. These lights 18 remain displayed to the individual, and the target response is received back from the individual verbally. The lights turned on during activation may be turned off, when the target response is being received back, so that the instructor may turn on lights when verbally responding. Alternatively, the flashing may also be repeated back by the instructor with the target response from the individual. The type of activation can be adjusted for the skill level and physical ability of the individual.

The step of requesting a target response can include showing a visual target, the visual target being related to the target response. The visual target can be an object, a picture display or a video display. FIG. 1 shows the object 42 as an apple. FIG. 4 shows the object 42 as an apple and a digital photoframe. The object shown on the picture display or video display is the visual target, not the screen or handheld device. In the present method, the target response is associated with identification of the visual target. The target response is pronunciation of the word “apple”, and the individual is requested to identify the object 42 as an apple or the object 42 in the photo or on the screen as an apple. Alternatively, the target response is an associated verbal response related to the visual target for more advanced individuals. Instead of simply identifying an object as an apple, the visual target could be an entire scene of a boy eating ice cream. The target response can be “The boy is eating”. The verbal response of the target response can be the answer to a yes-no question or answer to a narrative question. Each individual can adjust the method for an appropriate skill level, and the system and method of the present invention can be used as an individual learns more and progresses.

FIGS. 1-4 show one embodiment of the step of presenting at least one visual indicator. Visual indicators 18 without corresponding sound units are removed from a field of vision of the individual, and the slide members 28 are placed in the retracted position 30 for each sound unit corresponding to the target response. FIG. 1 showed covering visual indicators or lights 18 without corresponding sound units by placing the slide members 28 in the extended position 32. These slide members 28 are housed in the panel body 12. Removing the lights 18 without corresponding sound units from a field of vision of the individual is a teaching tool so that there are no extra visual cues to confuse the individual.

The step of associating the sound units with the visual indicators includes creating a different sensory interaction in addition to the desired verbal target response. FIGS. 1-4 show the visual indicators being lights activated by switches, wherein each light has a corresponding switch. A light is activated for each sound unit concurrent with presenting each sound unit. Each light and each corresponding switch is independent from any other light and switch. The switches can be pressure activated, such that pressing a switch to activate a corresponding light for each sound unit concurrent with presenting each sound unit can be required. The sound units of the target response are associated with a different sensory interaction, such as pressing a button, activating a switch, viewing a light, or pointing. Thus, the target response is the produced verbally by the individual concurrent with repeating the interaction with the visual indicators by the individual.

FIGS. 1-4 show one embodiment of an association of a multi-sensory cue as the activation of the lights 18 by the switches 20. The pressure switches at 22 require a tactile experience of applying a force to the light 18. Alternatively, the switch 20 can be a button 24. Again, the individual receives another tactile cue to associate with the sound unit of the target response. The activation of the light 18 by the switch 20 concurrent with the recitation of the sound unit creates an association to the individual so that the individual can learn to produce the verbal sound unit. This activation of the lights 18 by the individual, not the instructor, is another variation, which can be adjusted to the physical ability and skill level of the individual. The activation and recitation by the individual can be included in the steps of activating the lights and receiving the response.

In an alternative embodiment, the visual indicators are colored graphics instead of lights. The visual indicators as colored graphic displays, each being selected as any type or combination of geometric shapes, such as circles, squares, and triangles, in a selectable color. The complexity of visual indicators can be adjusted according to the skill level of the individual. These visual cues perform a similar association with each sound unit of the target response presented verbally by the instructor. The instructor or individual or both can point at a colored graphic for each sound unit concurrent with presenting each sound unit. In this embodiment, the association of the visual indicator is combined with the tactile pointing action to teach the sound units to the individual.

The step of receiving the target response includes repeating each sound unit verbally by the individual. Additionally, the instructor may de-activate each light 18 with a corresponding sound unit; then, the individual re-activates each light 18 for each corresponding sound unit concurrent with repeating each sound unit verbally. The act of switching lights on and off is another type of activation and receiving of target response from the individual. The association of the interaction with the visual indicators and the visual indicators themselves contribute to teaching the communication skills to the individual.

In another alternative embodiment, the step of presenting the target response can also include displaying the object or an image of the object, along with the aural sound units. Depending upon the level of ability of the individual, the target response may be presented with the actual object, for example, an apple for beginners or may be presented with an image of the object, for example, a photo of an apple. The images stand in for objects, while the target response is given. Some variations may include an image of an object on a display screen or digital screen. The object becomes associated with the sound units, based upon the object itself or the image of the object. Moving images on the display screen are also possible. Importantly, the object becomes associated with the target response, not physical item, such as a card, picture or screen.

Still another embodiment of the method for teaching speech and communication skills through an interactive display board to an individual with language disabilities includes the presentation of a request for a target response from the individual, the target response being comprised of a plurality of sound units. A plurality of visual indicators are presented corresponding to each sound unit of the target response, the visual indicators being a plurality of lights 18 mounted on a panel body 12 having a flat surface 14 and an interior volume 16. The lights 18 are linearly arranged on the flat surface 14, each light being activated by a switch 20 corresponding to each light 18. Each switch 20 is independent from any other switch, the lights 18 being housed in the interior volume 16 of the panel body 12. The lights 18 have a plurality of slide members 28 housed in the panel body 12 corresponding to each light 18. Each slide member 28 has an extended position 30 and a retracted position 32. The slide member 28 covers a corresponding light 18 in the extended position 32 and exposes the corresponding light 18 in the retracted position 30. The slide members 28 are independently moved between the retracted position 30 and the extended position 32 manually.

Each sound unit is associated with a corresponding visual indicator by activating adjacent lights 18 for each sound unit concurrent with presenting each sound unit. The corresponding light 18 has a corresponding slide member 28 in a retracted position 30. Lights 18 without an associated sound unit having a corresponding slide member 28 in an extended position 32. The lights 18 are activated by pressing a switch at 22 or a button 24.

Finally, the target response is received from the individual, the lights 18 being activated and having a corresponding slide member 28 in a retracted position 30 displayed to the individual.

The interactive display board promotes oral expressive language skills in individuals with language disabilities by presenting visual cues to assist in the comprehension and organization of sound. The present invention minimizes auditory cues when teaching language skills so that the only auditory cues are the sound units presented by the instructor. Other multi-sensory cues, such as visual or tactile cues, are associated with each sound unit to allow the individual to rely upon stronger visual skills to learn the sounds. The interactive display board is easy to use and easy to transport in any classroom or learning environment. The instructor can hold the light-weight device in front of a classroom full of students or place the device in a study carrel for single student instruction. The present invention includes the method of using such an interactive display board.

The foregoing disclosure and description of the invention is illustrative and explanatory thereof. Various changes in the details of the described method can be made without departing from the true spirit of the invention.

I claim:

1. A method for teaching speech and communication skills through an interactive display board to an individual with language disabilities, said method comprising the steps of:
requesting a target response from the individual, said target response being comprised of at least one sound unit;
presenting at least one visual indicator corresponding to each sound unit of said target response;
associating each sound unit with a corresponding visual indicator, the visual indicator being linearly arranged on a display board; and
receiving said target response from the individual, the visual indicator being displayed to the individual.

2. The method for teaching skills according to claim 1, wherein the step of requesting a target response comprises:
showing a visual target, said visual target being related to said target response.

3. The method of teaching skills according to claim 2, said visual target being an object.

4. The method of teaching skills according to claim 2, said visual target being a picture display.

5. The method of teaching skills according to claim 2, said visual target being a video display.

6. The method of teaching skills according to claim 2, said target response being associated with identification of said visual target.

7. The method of teaching skills according to claim 2, said target response being associated with a verbal response related to said visual target.

8. The method of teaching skills according to claim 1, each sound unit being selected from a group, being comprised of a phoneme, syllable, word, phrase, and a sentence.

9. The method of teaching skills according to claim 1, said visual indicators being mounted on a panel body in a linear arrangement.

10. The method of teaching skills according to claim 1, wherein the step of presenting at least one visual indicator further comprises:
removing visual indicators without corresponding sound units from a field of vision of the individual; and
placing said slide members in said retracted position for each sound unit corresponding to said target response.

11. The method of teaching skills according to claim 1, said visual indicators being lights activated by switches, wherein each light has a corresponding switch, wherein each light and each corresponding switch is independent from any other light and switch, and wherein the step of associating further comprises:
activating a light for each sound unit concurrent with presenting each sound unit.

12. The method of teaching skills according to claim 1, wherein said visual indicators are comprised of colored graphics, and wherein the step of associating comprises:
pointing at a colored graphic for each sound unit concurrent with presenting each sound unit.

13. The method of teaching skills according to claim 1, wherein the step of receiving said target response comprises:
repeating each sound unit verbally by the individual; and
interacting with each visual indicator corresponding to each sound unit of said target response concurrent with repeating each sound unit verbally.

14. An interactive display board for teaching speech and communication skills, according to the method of claim 1, said interactive display board comprising:
a panel body having a flat surface and an interior volume;
plurality of lights linearly arranged on said flat surface of said panel body, each light being activated by a switch corresponding to each light, each switch being independent from any other switch, said lights being housed in said interior volume of said panel body; and
plurality of slide members corresponding to said lights, each slide member having an extended position and a retracted position, each slide member covering a corresponding light in said extended position and exposing said corresponding light in said retracted position, each slide member being independently moved between said retracted position and said extended position.

15. The interactive display board according to claim 14, wherein each switch is pressure-activated.

16. The interactive display board according to claim 14, further comprising:
a mounting means on said panel body for requesting said target response associated with a visual display.

17. The interactive display board according to claim 14, further comprising:
a master switch to activate the plurality of lights and corresponding switches.

18. The interactive display board according to claim 14, further comprising:
a display stage, being removably attached to said panel body and aligned along a length of said panel body; and
a means for presenting a target response on said display stage.

19. A method for teaching speech and communication skills through an interactive display board to an individual with language disabilities, said method comprising the steps of:
presenting a request for a target response from the individual, said target response being comprised of a plurality of sound units;
presenting a plurality of visual indicators corresponding to each sound unit of said target response, said visual indicators being a plurality of lights mounted on a panel body having a flat surface and an interior volume, said lights linearly arranged on said flat surface of said panel body, each light being activated by a switch corresponding to each light, each switch being independent from any other switch, said lights being housed in said interior volume of said panel body, said lights having a plurality of slide members housed in said panel body corresponding to each light, each slide member having an extended position and a retracted position, each slide member covering a corresponding light in said extended position and exposing said corresponding light in said retracted position, each slide member being independently moved between said retracted position and said extended position;
associating each sound unit with a corresponding visual indicator by activating adjacent lights for each sound unit concurrent with presenting each sound unit, each corresponding light having a corresponding slide member in a retracted position, lights without an associated sound unit having a corresponding slide member in an extended position, said light being activated by pressing a switch; and
receiving said target response from the individual, said lights being activated and having a corresponding slide member in a retracted position displayed to the individual.

20. The method of teaching skills according to claim 19, wherein said step of presenting a request comprises:
showing a visual target, said visual target being related to said target response, said target response being associated with a verbal response related to said visual target by identification or by inquiry related to said visual target.
